(19) United States
(12) Patent Application Publication
(10) Pub. No.: US 2005/0267958 A1
(43) Pub. Date: Dec. 1, 2005

(54) Facilitating management of resources by tracking connection usage of the resources

(75) Inventors: Mark R. Gambino, Poughkeepsie, NY (US); David P. S. Parker, Poughkeepsie, NY (US)

Correspondence Address: HESLIN ROTHENBERG FARLEY & MESITI P.C., 5 COLUMBIA CIRCLE, ALBANY, NY, 12203, US

(73) Assignee: International Business Machines Corporation, Armonk, NY (US)

(21) Appl. No.: 10/833,741

(22) Filed: Apr. 28, 2004

(51) Int. Cl. G06F 15/173

(52) U.S. Cl. 709/223

(57) ABSTRACT

The amount of resources utilized by one or more connections of a communications environment is obtained. A determination is then made as to whether one or more of the connections is using a predominant amount of the resources. If a particular connection is using more of the resources than desired, then action is taken with respect to that connection.

### TECHNICAL FIELD

This invention relates, in general, to managing resources of a communications environment, and in particular, to determining the amount of resources being used by one or more connections of the environment to facilitate management of the resources.

### BACKGROUND OF THE INVENTION

A node of a communications environment has limited resources and situations can arise in which the resources are consumed by predominately one or more connections of the node. Although there are legitimate reasons for a connection using a large amount of resources, there may also be situations in which a connection is using an undesired amount of resources due to an error or denial of service. Should this occur, the availability of the node can become jeopardized, especially if those connections are allowed to continue to deplete the resources of the node. Potential impacts include node outages, the inability of the node to accept any new connections, existing connections becoming stalled, and/or the loss or corruption of data.

Previously, attempts have been made to limit the number of connections. However, this does not help in those situations in which it is an existing connection that is using a dominant amount of the resources. Thus, a need exists for a capability to determine the amount of resources being utilized by the connections. In particular, a need exists for a capability that identifies the one or more connections that are predominately utilizing the resources of a node.

### SUMMARY OF THE INVENTION

The shortcomings of the prior art are overcome and additional advantages are provided through the provision of a method of facilitating management of resources of communications environments. The method includes, for instance, identifying one or more connections of a communications environment; and determining for at least one connection of the one or more connections an amount of one or more resources being utilized by the at least one connection.

System and computer program products corresponding to the above-summarized method are also described and claimed herein.

Additional features and advantages are realized through the techniques of the present invention. Other embodiments and aspects of the invention are described in detail herein and are considered a part of the claimed invention.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts one embodiment of a communications environment incorporating and using one or more aspects of the present invention;

FIG. 2 depicts one example of resources tracked, in accordance with an aspect of the present invention;

FIG. 3 depicts one example of the resources being used by various connections, in accordance with an aspect of the present invention;

FIG. 4 depicts one embodiment of a requestor requesting and obtaining connection usage information, in accordance with an aspect of the present invention; and

FIG. 5 depicts one embodiment of the logic associated with managing connections, in accordance with an aspect of the present invention.

### BEST MODE FOR CARRYING OUT THE INVENTION

In accordance with an aspect of the present invention, a capability is provided for obtaining the amount of resources utilized by one or more connections of a communications environment. By obtaining the amount of resources used, a determination may be made as to whether a particular connection is utilizing a dominant amount of the resources. Should one or more of the connections be utilizing a dominant amount of resources, action may be taken with regards to those particular connections. For instance, if it is undesirable to have a particular connection using a dominant amount of a resource, then that particular connection is terminated, while leaving the other connections of the environment undisturbed.

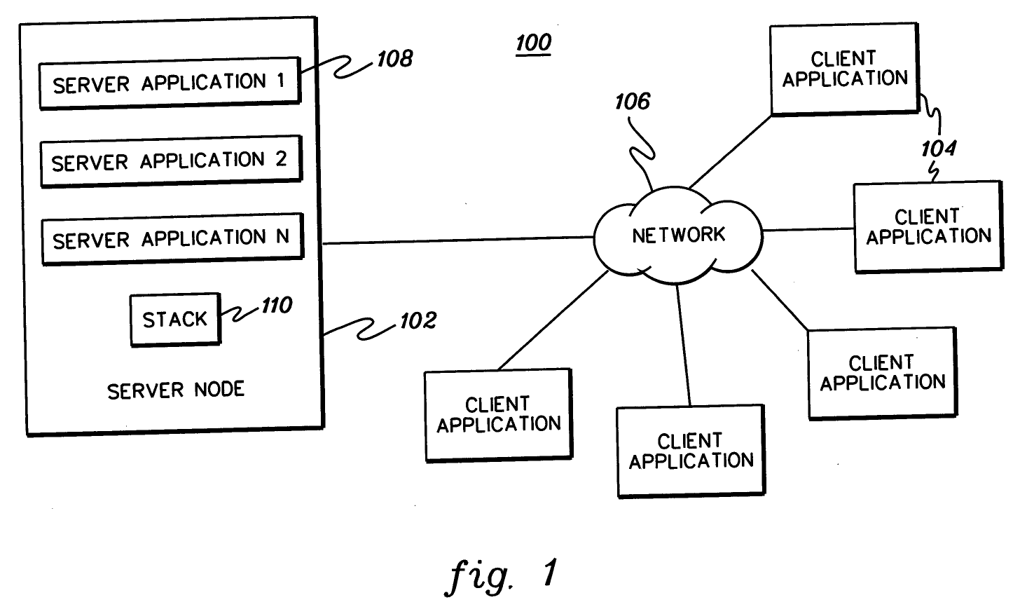

One embodiment of a communications environment incorporating and using one or more aspects of the present invention is depicted in FIG. 1. A communications environment 100 includes a node 102, such as a server, coupled to one or more client applications 104 via a network 106. In this particular example, the server is an eServer zSeries executing the TPF operating system, offered by International Business Machines Corporation, Armonk, N.Y., the client applications are Transmission Control Protocol/Internet Protocol (TCP/IP) applications executing on a computing unit, such as personal computer or laptop, and network 106 is a TCP/IP network. However, in other examples, the node may be other than an eServer zSeries, and/or the client applications and the network may be other than TCP/IP.

Executing within node 102 are one or more server applications 108, which may be accessed by the client applications. The server applications include, for instance, Web Servers, File Servers, Transaction Servers, Database Servers, as well as other applications.

Node 102 also includes at least one stack 110 that is used in communications with the client applications. The stack includes, for instance, rules of the communications protocol, buffers, code and data structures utilized during and/or for communications. The stack is also the facility by which connection usage information is obtained, in accordance with an aspect of the present invention. Since the communications protocol is TCP/IP, in this example, the stack is referred to as a TCP/IP stack.

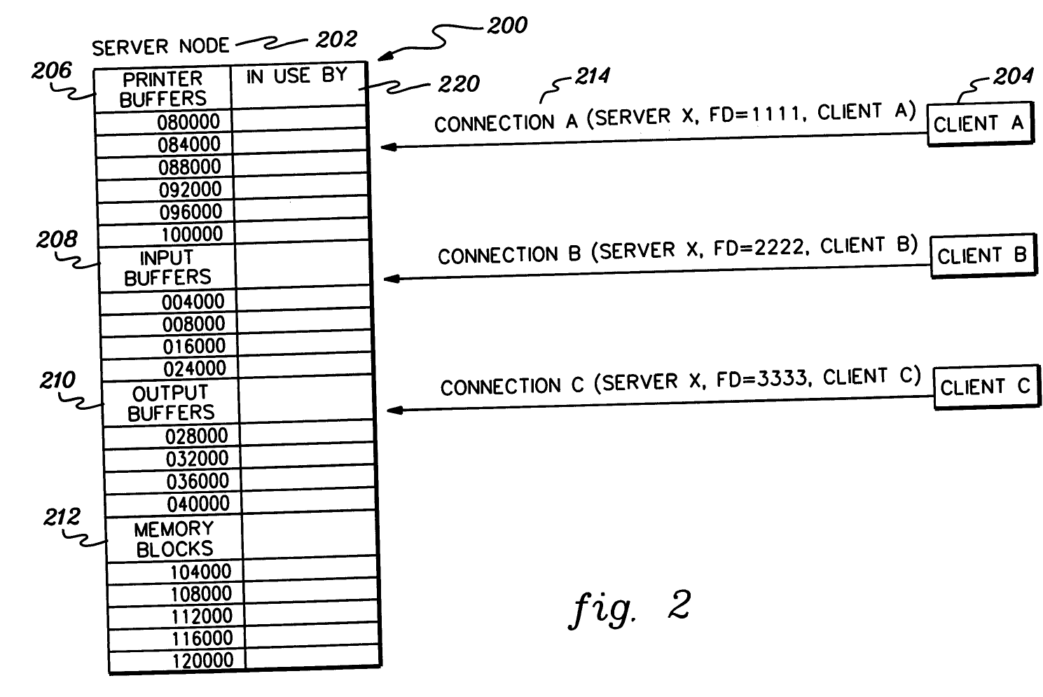

A connection (e.g., a socket connection) is initiated by a client application. In particular, client application 104 establishes an active connection with node 102 via network 106. Each active connection has a token, known as a file descriptor, associated therewith which uniquely identifies the connection. A connection utilizes various resources of the node, and in accordance with an aspect of the present invention, the resources utilized by the connection are tracked or determined upon request. This connection usage information is maintained, for instance, within a data structure of the stack, as described with reference to FIG. 2.

As depicted in FIG. 2, a data structure 200, such as a table, includes a list of the resources of a server node 202 that may be utilized by a client application 204. The resources include printer buffers 206, input buffers 208, output buffers 210 and memory blocks 212, as examples. The particular buffers and/or blocks associated with each resource are indicated in the table. For example, printer buffers 080000, 084000, 088000, 092000, 096000 and 100000 are available for use by the client applications; as well as input buffers 004000, 008000, 016000 and 024000; etc.

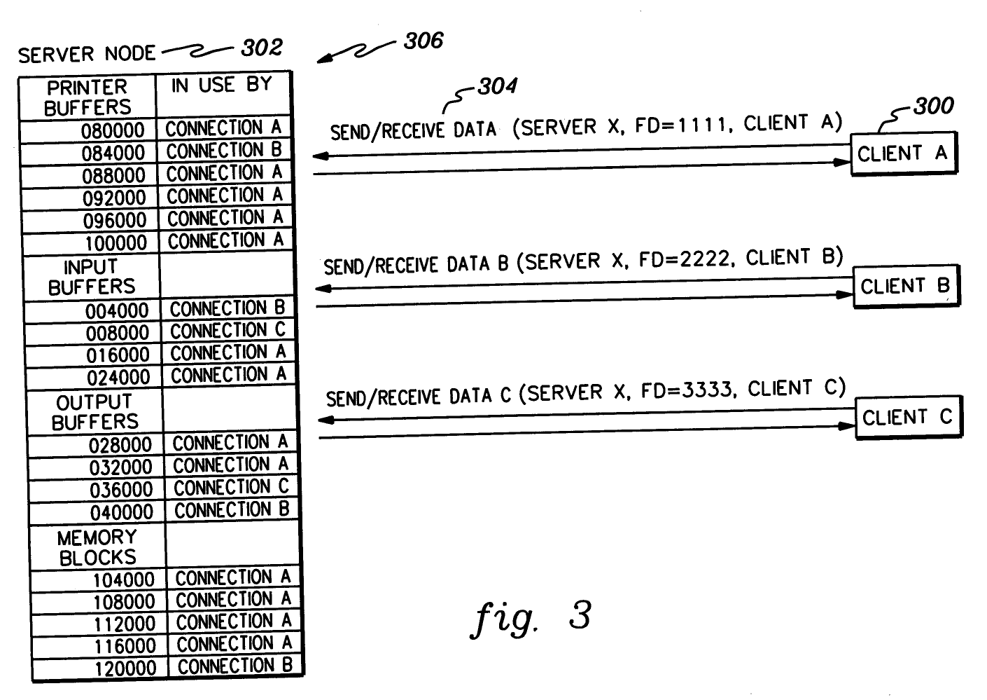

In one embodiment, the node (e.g., code or logic in the stack) tracks resource usage as a client connects to the server and uses those resources. For example, as shown in FIG. 2, Client A 204 establishes a connection 214 with server 202. The server is identified as Server X and the connection has a file descriptor of 1111. The resources used by that connection are tracked through the file descriptor and placed in the “In Use By” fields 220. Similar processing is performed for Client B and Client C, as further described with reference to FIG. 3.

As shown in FIG. 3, as a client connects to a server and generates transactions that use different resources, the node (e.g., code or logic in the stack) keeps track of the resources used (e.g., by following the resource chain pointers of the stack). For instance, Client A 300 connects to a server 302 and generates send/receive data transactions 304. The resources used by Connection A, which is identified by file descriptor 1111, in this example, are identified in a data structure 306. For example, it is shown that Connection A is using printer buffers 080000, 088000, 092000, 096000, and 100000; input buffers 016000, 0240000; output buffers 028000, 032000; and memory blocks 104000, 108000, 112000, and 116000. Similarly, the resources used by Connections B and C are also tracked. Although in the above example, the resources used are tracked when they are obtained and released, in another example, the resources used are obtained dynamically, in response to a request for usage.

By obtaining the amount of resources used by a connection, a determination may be made as to which, if any, of the one or more connections is using a dominant amount of the resources. As examples, an operator interface, such as a query command can be used to retrieve the information, and/or a program interface, such as an automated program, can be created that issues a function to retrieve the information. Regardless of whether it is a command or an automated function, the request can be a request to identify the connections using the most system resources (overall or a specific type), or it may be a request to identify the amount of system resources being used by one or more particular connections.

In the case where the requestor issues a request with one or more specific connections as input, the diagnostic tool (e.g., command or program) interfaces with the TCP/IP stack to obtain resource usage information regarding the specified connection(s) and returns that information to the requestor.

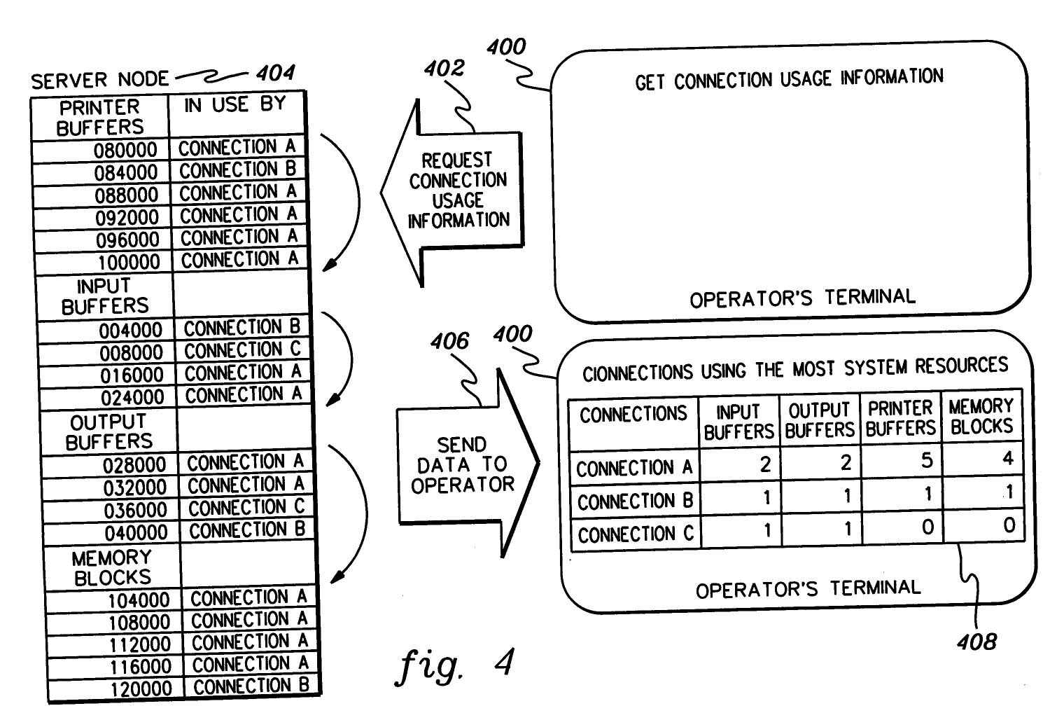

In the case where the requestor issues a request to find the top N number of connections using the most system resources, the diagnostic tool interfaces with the stack to obtain resource information for each connection in the system. The tool then sorts the information based on the requestor's input criteria for type of system resource and returns to the requestor information on the top N entries in the sort. This is further described with reference to FIG. 4.

As shown in FIG. 4, an operator at an operator's terminal 400 issues a command or runs a function to obtain connection usage information 402. The command is received by a server node 404, coupled to operator's terminal 400, which determines the requested information. For example, a program or command executing on the server node extracts the previously obtained information from the stack or determines the information, on demand, and sorts the information, if desired or necessary. The server node then sends the obtained data 406 to the operator's terminal. The operator is provided with a data structure 408 (e.g., a list, table, etc.) identifying the requested information. In this example, the requested information includes the connections using the most system resources.

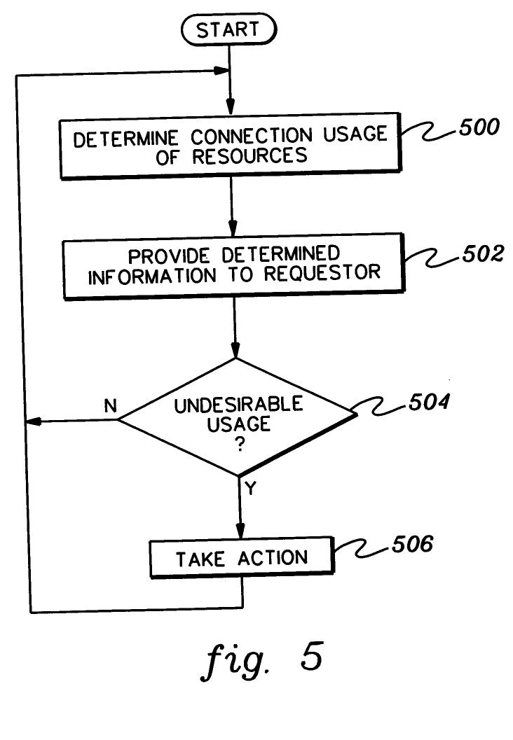

In response to the operator obtaining this information, the operator may take action with regards to the one or more connections using the most resources. This is further described with reference to FIG. 5, which depicts one embodiment of the logic associated with tracking connection usage and taking action with regards to the tracked information.

Referring to FIG. 5, initially, connection usage of resources is determined, STEP 500. As described above, this determining includes tracking the usage as the resources are consumed and released, or it may include determining the usage on demand. The determined connection usage information is then provided to a requestor, STEP 502. The requestor may request the connection usage information for all of the connections, it may specifically request connection usage information for one or more particular connections, it may request usage information related to one or more particular resources, or yet further, it may specifically request the connection usage information for those connections using a dominant amount of system resources. Many other variations also exist.

In response to the requestor receiving the connection usage information, the requestor determines whether the usage by one or more connections is undesirable (e.g., too dominating), INQUIRY 504. If the usage is acceptable, then processing continues with determining the connection usage, STEP 500 (or processing is terminated, in another example). However, if the usage is unacceptable, then action is taken, STEP 506. The action taken may vary, but in one example, it includes terminating the connections that are using an undesirable amount of system resources. This terminating effects only those specific connections that are terminated, while leaving undisturbed the other connections. Processing then continues with STEP 500 (or ends).

Described in detail above is a capability for obtaining the amount of resources used by one or more connections of a communications environment. This obtaining enables a determination to be made as to which, if any, of the one or more connections of the environment is utilizing a dominant amount of the resources. An operator or program can inquire about the resources used by a specific connection by passing the connection's file descriptor as input to a tool (e.g., an interface), or can request information on the top N number of connections using the most system resources. Input can also include the type of system resource. For example, an operator may inquire about the top ten connections using the most core memory.

Advantageously, one or more aspects of the present invention can be used to identify existing and potentially troubled connections that are using the most resources. This is useful in many situations, and particularly, in real-time processing and/or continuous availability systems, such as with reservation systems, banking systems, etc. One or more aspects of the present invention can be used with a variety of environments, including a variety of nodes and/or networks. Further, it can be used to track a wide variety of resources, including network resources, application resources, database resources, file resources and/or other system resources.

Although an example of an environment is described above, many other environments, including different types of environments, may include and/or benefit from one or more aspects of the present invention. For example, the environment may include one or more networks and/or client applications that are other than TCP/IP. For example, one or more aspects of the present invention can be employed with other communications protocols, such as the System Network Architecture (SNA) or X.25 protocol, as well as other protocols. Yet further, the environment may include a plurality of nodes, a plurality of networks and/or more or less client applications. Moreover, a node may be other than a server node, such as a mainframe, laptop or other type of computing unit. Yet further, the client applications may run on other than personal computers or laptops, and there may be many types of client applications, as well as server applications. Many other variations exist and are considered a part of the claimed invention.

As yet a further example, the connection usage information may be maintained in other than the stack, such as in memory, external storage, etc. Further, the connections may be identified by other than file descriptors, such as other types of identifiers. Moreover, the logic employed to determine connection usage, determine if action is to be taken and to take action can be independent of the stack. For instance, it can be included in a program running in the node or in a facility coupled to the node.

The capabilities of one or more aspects of the present invention can be implemented in software, firmware, hardware or some combination thereof.

One or more aspects of the present invention can be included in an article of manufacture (e.g., one or more computer program products) having, for instance, computer usable media. The media has therein, for instance, computer readable program code means or logic (e.g., instructions, code, commands, etc.) to provide and facilitate the capabilities of the present invention. The article of manufacture can be included as a part of a computer system or sold separately.

Additionally, at least one program storage device readable by a machine embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

1. A method of facilitating management of resources of communications environments, said method comprising:
identifying one or more connections of a communications environment; and
determining for at least one connection of the one or more connections an amount of one or more resources being utilized by the at least one connection.

2. The method of claim 1, wherein said at least one connection comprises at least one active socket connection.

3. The method of claim 1, further comprising:
determining whether a connection of the at least one connection is utilizing a dominant amount of one or more resources; and
taking action in response to the determining indicating that the connection is utilizing the dominant amount.

4. The method of claim 3, wherein said taking action is targeted at the connection utilizing the dominant amount and not at one or more other connections of the communications environment.

5. The method of claim 3, wherein utilizing the dominant amount of one or more resources is unacceptable, and the taking action comprises terminating the connection utilizing the dominant amount.

6. The method of claim 1, wherein the determining comprises tracking usage of the one or more resources by the at least one connection as the one or more resources are used.

7. The method of claim 6, wherein the tracked usage is maintained in a stack of the communications environment, said stack being based on a communications protocol of the communications environment.

8. The method of claim 1, wherein said determining is in response to a request associated with an amount of resources being utilized.

9. The method of claim 1, wherein the one or more resources comprises at least one of printer buffers, input buffers, output buffers and memory blocks.

10. A system of facilitating management of resources of communications environments, said system comprising:
means for identifying one or more connections of a communications environment; and
means for determining for at least one connection of the one or more connections an amount of one or more resources being utilized by the at least one connection.

11. The system of claim 10, wherein said at least one connection comprises at least one active socket connection.

12. The system of claim 10, further comprising:
means for determining whether a connection of the at least one connection is utilizing a dominant amount of one or more resources; and
means for taking action in response to the determining indicating that the connection is utilizing the dominant amount.

13. The system of claim 12, wherein the taking action is targeted at the connection utilizing the dominant amount and not at one or more other connections of the communications environment.

14. The system of claim 12, wherein utilizing the dominant amount of one or more resources is unacceptable, and the means for taking action comprises means for terminating the connection utilizing the dominant amount.

15. The system of claim 10, wherein the means for determining comprises means for tracking usage of the one or more resources by the at least one connection as the one or more resources are used.

16. The system of claim 15, wherein the tracked usage is maintained in a stack of the communications environment, said stack being based on a communications protocol of the communications environment.

17. The system of claim 10, wherein said means for determining is in response to a request associated with an amount of resources being utilized.

18. The system of claim 10, wherein the one or more resources comprises at least one of printer buffers, input buffers, output buffers and memory blocks.

19. A system of facilitating management of resources of communications environments, said system comprising:
one or more connections of a communications environment; and
a node to determine for at least one connection of the one or more connections an amount of one or more resources being utilized by the at least one connection.

20. An article of manufacture comprising:
at least one computer usable medium having computer readable program code logic to facilitate management of resources of communications environments, the computer readable program code logic comprising:
identify logic to identify one or more connections of a communications environment; and
determine logic to determine for at least one connection of the one or more connections an amount of one or more resources being utilized by the at least one connection.

21. The article of manufacture of claim 20, wherein said at least one connection comprises at least one active socket connection.

22. The article of manufacture of claim 20, further comprising:
determine logic to determine whether a connection of the at least one connection is utilizing a dominant amount of one or more resources; and
action logic to take action in response to the determining indicating that the connection is utilizing the dominant amount.

23. The article of manufacture of claim 22, wherein the taking action is targeted at the connection utilizing the dominant amount and not at one or more other connections of the communications environment.

24. The article of manufacture of claim 22, wherein utilizing the dominant amount of one or more resources is unacceptable, and the action logic comprises terminate logic to terminate the connection utilizing the dominant amount.

25. The article of manufacture of claim 20, wherein the determine logic comprises track logic to track usage of the one or more resources by the at least one connection as the one or more resources are used.

26. The article of manufacture of claim 25, wherein the tracked usage is maintained in a stack of the communications environment, said stack being based on a communications protocol of the communications environment.

27. The article of manufacture of claim 20, wherein the determining is in response to a request associated with an amount of resources being utilized.

28. The article of manufacture of claim 20, wherein the one or more resources comprises at least one of printer buffers, input buffers, output buffers and memory blocks.
